(19) United States
(12) Patent Application Publication
(10) Pub. No.: US 2026/0252933 A1
(43) Pub. Date: Aug. 27, 2026

(54) System and Method for Wave-Interference-Based Collapse Computation Using Coupled Wavefunctions

(71) Applicant: LARRY LIM KHENG CHEONG, Singapore (SG)

(72) Inventor: LARRY LIM KHENG CHEONG, Singapore (SG)

(21) Appl. No.: 19/651,619

(22) Filed: Apr. 18, 2026

Related U.S. Application Data
(63) Continuation-in-part of application No. 19/173,849, filed on Apr. 9, 2025.

(51) Int. Cl. G06N 10/20

(52) U.S. Cl. CPC G06N 10/20

(57) ABSTRACT

A computer-implemented system and method for determining collapse states in quantum and probabilistic systems using wave-interference-based computation are disclosed. The system models collapse as a deterministic process arising from interaction between a system wavefunction and one or more observer or environmental wavefunctions. A modified Schrödinger-type formulation is used to compute a real-valued collapse intensity based on amplitude coupling and phase alignment between interacting wavefunctions. The system further aggregates the collapse intensity over a spatial domain to generate a scalar collapse measure, which is compared against a predefined threshold to determine collapse conditions. The invention enables simulation, prediction, and control of collapse behavior across quantum systems, probabilistic computation, and collapse-driven decision architectures.

### CROSS-REFERENCE TO RELATED APPLICATIONS

This application is a continuation-in-part of U.S. patent application Ser. No. 19/173,849, filed Apr. 9, 2025, the disclosure of which is incorporated herein by reference in its entirety.

Subject matter disclosed in the present application that is common to U.S. application Ser. No. 19/173,849 is entitled to the priority date of Apr. 9, 2025. Subject matter first introduced in this continuation-in-part application is entitled to the filing date of the present application.

### STATEMENT REGARDING RELATED CO-PENDING APPLICATION

The present invention is complementary to co-pending U.S. patent application Ser. No. 19/571,508, which describes system-level architectures for detecting and managing collapse conditions in complex systems.

Whereas the co-pending application focuses on system design, decision logic, and application-level implementations, the present invention provides the underlying wave-based computational mechanism for determining collapse intensity based on wavefunction interaction.

### FIELD OF THE INVENTION

The invention relates to computational and physical systems for modeling collapse behavior in quantum and probabilistic systems. More specifically, it relates to systems that compute collapse states using wave-interference mechanisms between coupled wavefunctions.

### BACKGROUND OF THE INVENTION

Conventional quantum mechanical frameworks describe system evolution using linear Schrödinger equations while treating wavefunction collapse as probabilistic or externally imposed. Existing interpretations do not provide a deterministic, computationally implementable mechanism for collapse based on measurable interaction.

Similarly, computational systems in artificial intelligence and probabilistic modeling rely on statistical inference and lack mechanisms to model discontinuous transitions arising from interference between interacting states.

There exists a need for a system that:
models collapse as a deterministic process arising from wave interaction;
incorporates both system and observer wavefunctions;
computes collapse using amplitude and phase relationships; and
enables detection and control of collapse behavior.

### SUMMARY OF THE INVENTION

The invention provides a system comprising:
a wavefunction representation module;
an interference computation module;
a collapse computation module;
a scalar aggregation module;
a threshold detection module; and
an output module.

The system computes collapse intensity based on interaction between a system wavefunction and an observer or environmental wavefunction using a modified wave formulation incorporating amplitude and phase-dependent terms.

In certain embodiments, the output module is configured to automatically execute control actions that modify system behavior without user intervention, including altering computational workflows, adjusting simulation parameters, or triggering system-level state changes.

### DETAILED DESCRIPTION OF THE INVENTION

### 1. Wavefunction Representation

A system wavefunction Ψₚ(r,t) and an observer or environmental wavefunction Ψₒ(r,t) are defined over spatial domain r and time t.

Each wavefunction comprises amplitude and phase components.

### 2. Modified Wave Interaction Equation

The system wavefunction evolves according to:

$$i ℏ \partial {Ψ}_{p} ( r , t ) / \partial t = ( - ( {ℏ}^{2} / 2 m ) {∇}^{2} + V ( r ) + γ {\vert {Ψ}_{o} ( r , t ) \vert}^{2} - δ \cdot Re ( {Ψ}_{o} ( r , t ) ) ) {Ψ}_{o} ( r , t )$$

In certain embodiments, the dissipation term may alternatively be represented as a complex-valued interaction term consistent with the parent application.

### 3. Phase Interaction

Relative phase difference is defined as:

$$Δ θ ( r , t ) = {θ}_{o} ( r , t ) - {θ}_{p} ( r , t )$$

Constructive interference occurs when cos(Δθ)>0, and destructive interference occurs when

$$cos ( Δ θ ) < 0.$$

### 4. Collapse Intensity Function

A real-valued collapse intensity field is defined:

$$C ( r , t ) = γ {\vert {Ψ}_{p} ( r , t ) \vert}^{2} {\vert {Ψ}_{o} ( r , t ) \vert}^{2} cos ( Δ θ ( r , t ) ) - δ {\vert {Ψ}_{o} ( r , t ) \vert}^{2}$$

The dissipative contribution δ|Ψₒ(r,t)|² arises from the dissipation term in the modified Schrödinger equation defined in Section 2.

### 5. Scalar Collapse Measure

The collapse intensity field is aggregated over a spatial domain Ω to produce a scalar collapse measure:

$$C ( t ) = \int Ω C ( r , t ) dr$$

### 6. Collapse Condition

Collapse is determined when:

$$C ( t ) \geq τ$$

Where τ is a predefined threshold.

### 7. Curvature-Based Collapse Signal

A curvature-based signal is defined:

$${Ψ}_{p}^{″} ( t ) = {d}^{2} / {dt}^{2} 〈 x ( t ) 〉$$

This signal provides an early indicator of collapse onset.

### 8. Output and Control

Upon detection of a collapse condition, the system automatically executes control actions that modify the operational state of a computational process, simulated environment, or physical system.

### 9. Applications

The system may be applied to:
quantum measurement systems;
pharmaceutical and biological systems;
financial systems for instability detection;
industrial control systems;
probabilistic computation frameworks;
quantum memory and quantum state control systems.

### Advantages

deterministic collapse computation
phase-sensitive interference modeling
real-valued scalar collapse detection
automated system control
applicability across multiple domains

### Alternative Embodiments

multi-wave interaction systems
adaptive threshold mechanisms
machine-learning-assisted parameter tuning

1. A system for determining collapse states in a computational or physical system, comprising:
(a) a wavefunction representation module configured to represent a system wavefunction and at least one observer or environmental wavefunction;
(b) an interference computation module configured to compute interaction between said wavefunctions using a modified Schrödinger-type formulation including amplitude-dependent and phase-dependent interaction terms;
(c) a collapse computation module configured to compute a spatially distributed collapse intensity field based on amplitude coupling and phase alignment between said wavefunctions;
(d) a scalar aggregation module configured to aggregate the collapse intensity field over a spatial domain to produce a scalar collapse measure;
(e) a threshold detection module configured to determine a collapse condition when the scalar collapse measure exceeds a predefined threshold; and
(f) an output module configured to automatically generate and execute a control action that modifies an operational state of a computational process, physical system, or simulated environment in response to said collapse condition.

2. The system of claim 1, wherein the collapse intensity field is computed as:
$$C ( r , t ) = γ {\vert {Ψ}_{p} ( r , t ) \vert}^{2} {\vert {Ψ}_{o} ( r , t ) \vert}^{2} cos ( Δ θ ( r , t ) ) - δ {\vert {Ψ}_{o} ( r , t ) \vert}^{2} .$$

3. The system of claim 1, wherein the scalar collapse measure is computed as:
$$C ( t ) = \int Ω C ( r , t ) dr .$$

4. The system of claim 1, wherein the relative phase difference Δθ is computed from phase components of the system wavefunction and the observer wavefunction, and wherein said phase difference modulates the collapse intensity field via cos(Δθ).

5. The system of claim 1, wherein constructive interference increases collapse intensity and destructive interference reduces collapse intensity.

6. The system of claim 1, wherein a curvature-based collapse signal is defined as:
$${Ψ}_{p}^{″} ( t ) = {d}^{2} / {dt}^{2} 〈 x ( t ) 〉$$
and wherein said curvature-based collapse signal is provided as an independent input to the threshold detection module and contributes to determining the collapse condition prior to the scalar collapse measure exceeding the predefined threshold.

7. The system of claim 1, wherein the output module generates a control action selected from localization, parameter adjustment, or system modification.

8. A method for determining collapse states, comprising:
(a) representing system and observer wavefunctions;
(b) computing interaction using a modified wave equation;
(c) computing a collapse intensity field based on amplitude coupling and phase alignment;
(d) aggregating the collapse intensity field to produce a scalar collapse measure;
(e) detecting a collapse condition; and
(f) generating and executing an output based on said collapse condition.

9. A non-transitory computer-readable medium storing instructions that, when executed, perform the method of claim 8.

10. The system of claim 1, wherein the system is applied to pharmaceutical or biological systems.

11. The system of claim 1, wherein the system is applied to financial systems for detecting instability or collapse conditions.

12. The system of claim 1, wherein the system is applied to industrial or engineered systems for detecting failure conditions.

13. The system of claim 1, wherein the system is applied to quantum measurement systems.

14. The system of claim 1, wherein the system is applied to quantum memory or quantum state control systems.

15. The system of claim 1, wherein the control action comprises automatically modifying execution of a computational process, simulation parameters, or operational state of a physical system.

16. The system of claim 1, wherein the scalar aggregation module aggregates a spatially distributed interference field derived from wavefunction interaction into the scalar collapse measure such that collapse determination is based on collective spatial interference behavior rather than localized state variables.
